(19) United States
(12) Patent Application Publication
(10) Pub. No.: US 2014/0143046 A1
(43) Pub. Date: May 22, 2014

(54) ADVERTISEMENT PACKAGER

(71) Applicant: Specific Media LLC, Irvine, CA (US)

(72) Inventors: Christopher Mark Doe, Playa Del Rey, CA (US); Jason J. A. Knapp, Solana Beach, CA (US)

(73) Assignee: Specific Media LLC, Irvine, CA (US)

(21) Appl. No.: 14/084,432

(22) Filed: Nov. 19, 2013

Related U.S. Application Data
(60) Provisional application No. 61/728,639, filed on Nov. 20, 2012.

(51) Int. Cl. G06Q 30/02

(52) U.S. Cl. CPC G06Q 30/0277
USPC 705/14.48; 705/14.73; 705/14.68

(57) ABSTRACT

A method, apparatus, system, and computer program product provide the ability to select and display advertisements. A request for advertisements is issued to an advertisement server. An advertisement package comprised of a set of advertisements is received from the advertisement server. The set of advertisements from the advertisement package are loaded. Advertisements in the set of advertisements are delivered for display by display devices. The advertisements that are displayed are tracked in a log that is uploaded to the advertisement server.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Ser. No. 61/728,639, filed on Nov. 20, 2012, by Christopher Mark Doe and Jason J. A. Knapp, entitled “ADVERTISEMENT PACKAGER,” attorneys' docket number 257.67-US-P1.

This application is related to the following co-pending patent applications, which applications are incorporated by reference herein:

U.S. patent application Ser. No. 13/751,884, entitled “SYSTEM AND METHOD OF AUGMENTING LINEAR BROADCAST ADVERTISING”, by Brian Jentz, Steven Michael Cormie, Christopher Forrest Gordon, David John Terry Evans, and Marcus Christakis Liassides, filed on Jan. 28, 2013, Attorney Docket No. 257.41-US-U1, which application claims priority to U.S. Patent Application Ser. No. 61/591,336, entitled “SYSTEM AND METHOD OF AUGMENTING LINEAR BROADCAST ADVERTISING”, by Brian Jentz, Steven Michael Cormie, Christopher Forrest Gordon, David John Terry Evans, and Marcus Christakis Liassides, filed on Jan. 27, 2012, Attorney Docket No. 257.41-US-P1;

U.S. patent application Ser. No. 13/954,665, entitled “VOLUME BAR ADVERTISING”, by Steven Michael Connie and Brian Jentz, filed on Jul. 30, 2013, Attorney Docket No. 257.65-US-U1, which application claims priority to U.S. Patent Application Ser. No. 61/677,280, entitled “TELEVISION VOLUME BAR ADVERTISING”, by Steve Cormie and Brian Jentz, filed on Jul. 30, 2012, Attorney Docket No. 257.65-US-P1; and

U.S. patent application Ser. No. 14/061,398, entitled “SESSION BASED ADVERTISING”, by Steven Michael Connie, Brian Jentz, and Christopher Mark Doe, filed on Oct. 23, 2013, Attorney Docket No. 257.66-US-U1, which application claims priority to U.S. Patent Application Ser. No. 61/718,321, entitled “SESSION BASED ADVERTISING”, by Steven Michael Connie, Brian Jentz, and Christopher Mark Doe, filed on Oct. 25, 2012, Attorney Docket No. 257.66-US-P1.

### BACKGROUND OF THE INVENTION

1. Field of the Invention

The present invention relates generally to advertising, and in particular, to a method, apparatus, and article of manufacture for enabling digital advertising to/on devices without a constant Internet connection.

2. Description of the Related Art

Audio/video media content is consumed by users via a plethora of different hardware platforms in a variety of different formats. Furthermore, such audio/video media content is delivered to such users using a variety of different delivery mechanisms (e.g., broadcast, multicast, unicast, etc.). Regardless of the hardware platform or format, it is often desirable for the content owner, broadcaster, hardware owner, etc. to monetize the delivery and/or consumption of the media content. Advertising is a predominately used mechanism for monetization. Often times, advertising is transmitted, in real-time, to devices for display. In this regard, devices may maintain an Internet connection that is used to request and receive advertisements that are displayed. Accordingly, it is problematic if such devices lose or do not maintain an active/constant Internet connection. Such problems may be better understood with a description of prior art display devices and advertising on such devices.

Both advertisers and those desiring to monetize the media content delivery/consumption often seek new and creative ways to deliver/display advertising to users/consumers. While existing advertising mechanisms are plentiful, it is always desirable to further improve and find new/unique ways to deliver/display advertising to users as well as to find new ways to increase the advertising revenue and to maximize click-thru of advertisement by consumers.

Television based advertising commonly consists of commercials and advertisement placements during programming. However, with the increased use of the Internet and media viewing devices, televisions and media viewing devices may be connected to the Internet. Such a connection may enable new advertising paradigms and mechanisms for delivering advertisements on connected devices. Prior art techniques that utilize connected devices provide for advertising that is largely based around the electronic program guide (EPG) and content search. An EPG is an interactive program guide that provides users of television, radio, and other media applications with continuously updated menus displaying programming or scheduling information for current and upcoming programming. Advertisements via EPGs and content search engines provide for display ads, that, when selected transport the user/display to a microsite (referred to as a click-thru). Click-thru rates in a connected television based context have been over ten times more than a typical click-thru rate for a web-page banner advertisement. Accordingly, it is desirable to find and utilize other methods of advertising in the context of connected media viewing devices.

However, while advertising on connected devices may be useful, it is problematic when such devices do not have an Internet connection such that advertisements cannot be readily received. For example, the airline advertisement business is very archaic. The airlines outsource all media sales to outside firms who do not optimize any of the advertisement inventory. Such a lack of optimization and inability to utilize advertisement technology associated with Internet connected devices is problematic. Further, the inability to request/receive advertisements in real-time can result in a loss of advertising revenue. In view of the above, what is desirable is the capability to enable digital advertising in connected devices that do not have constant Internet connectivity.

### SUMMARY OF THE INVENTION

Embodiments of the invention enable digital advertising in connected devices without constant Internet connectivity. Publishers may request digital media assets (including advertisements) in real-time for showing/display at a later date/time.

### BRIEF DESCRIPTION OF THE DRAWINGS

Referring now to the drawings in which like reference numbers represent corresponding parts throughout:

FIG. 1 is an exemplary hardware and software environment/platform used to implement one or more embodiments of the invention;

FIG. 2 illustrates the interaction between different components of the system/platform of embodiments of the invention;

FIG. 3 illustrates a content management system that communicates with an advertisement server to receive an advertisement package for future display on display devices in accordance with one or more embodiments of the invention; and

FIG. 4 illustrates the logical flow for utilizing an ad package in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

Embodiments of the invention merge offline advertisement delivery with online ad serving to enable numerous online features, such as budgeting, targeting, analytics, etc. to an offline world. In this regard, an advertisement network may be extended offline (e.g., for use in avionics or an avionic ad network for premium travel users (high CPM [cost per thousand impressions]) and with Internet connected devices (such as televisions).

Hardware Environment

As used herein, “media content” refers to audio, audio-video, video, images, and/or any other content that can be viewed on a display device. A variety of different hardware platforms may be utilized to deliver and view media content. Embodiments of the invention are intended to apply to all and/or a subset of such platforms. Several exemplary platforms are described herein but the invention is not limited to such platforms.

It may be useful to note that as used herein, the hardware platform includes several components: (1) the screen/monitor/display on which media content is viewed (referred to as “display device”); (2) the hardware that receives the media content from a source and formats/delivers the content to the display device (referred to as a “media receiver”); and (3) the transmission mechanism/distribution system for the media content. It may also be noted that the functionality performed by each of the components may at times be performed by other components in the hardware platform. In addition, the components may be integrated together. For example, the display device may be integrated into and be part of the media receiver.

Embodiments of the invention may be utilized in the context of television viewing but may also apply to any device that is capable of viewing/displaying media content including cellular devices (e.g., cellular phones), personal digital assistants (PDAs), tablet computers (e.g., the iPad™ tablet), music players (e.g., MP3 players such as iPod™ music players), set-top-boxes (STBs), games consoles, etc. In the context of television viewing, the display device may consist of traditional television display devices (e.g., LED [light emitting diode] televisions, plasma televisions, LCD [liquid crystal display], cathode ray tube [CRT] displays, etc.). Such traditional display devices may receive the media content directly from a broadcast source (e.g., via an integrated antenna or via cable, wireless network, etc.) wherein the tuner/receiver is integrated into the display device. Alternatively, the display device may be connected to a tuner/media receiver (e.g., a set top box) that receives the content, decodes the content, etc. for display on the display device. Such a set top box (STB) may receive the content via satellite, cable, broadcast, etc.

Further, media content may be received via a Content Management System (CMS) (e.g., an avionics system) that controls/enables the delivery of media content and/or advertisements to one or more display devices. Such a CMS may be utilized on any type of transportation vehicle or system of mass transport such as an airplane, ocean vessel (e.g., cruise ship or ferry), automobile (e.g., a bus), train/subway, etc. Thus, as used herein, the term CMS refers to a system capable of delivering media content and/or advertisements, within a local network, to devices that may not have constant Internet connectivity. In other words, the CMS is the offline network that powers content and advertising delivery in a local network.

Accordingly, the media content may be viewed on a display device that receives the media content via the CMS. In such an embodiment, the display device may be a computer monitor. Alternatively, the television itself may be “connected” to the CMS. In alternative embodiments, the receiver that delivers content to a display device may consist of hardware/media player specifically directed towards television viewing. Examples of such devices include a Boxee device, an AppleTV™ device, a Google™ set-top box, a Roku™ television device, etc. In yet another embodiment, the display device may consist of a cellular device/phone that receives media content via a cellular network.

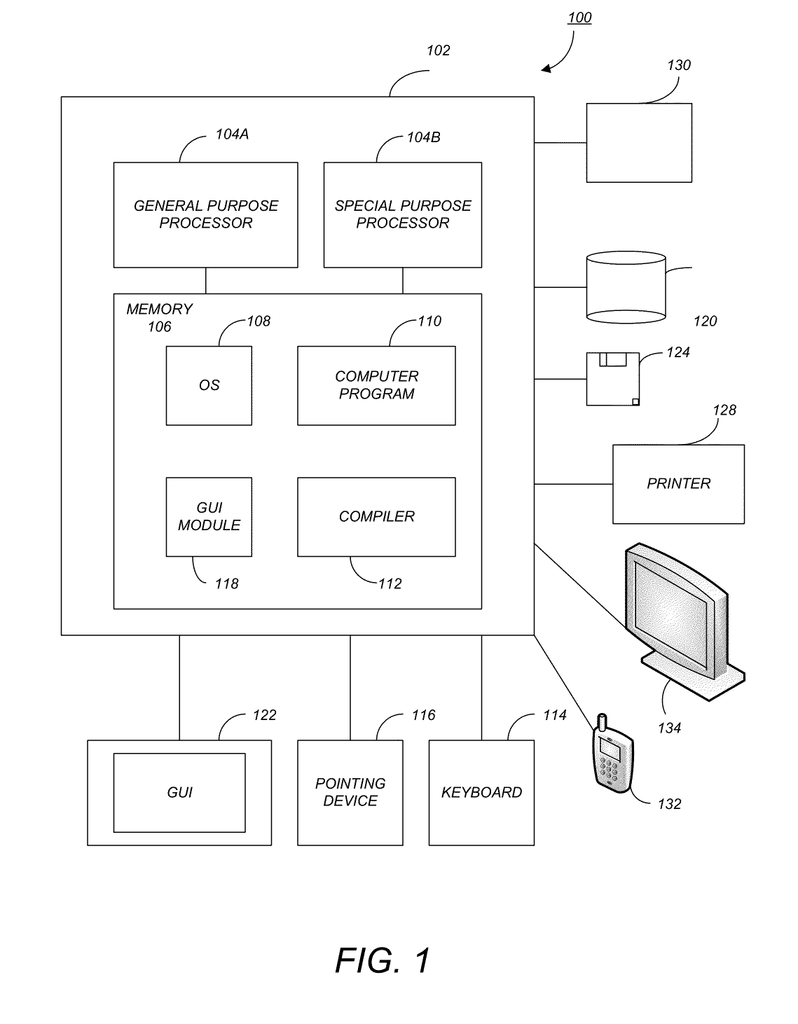

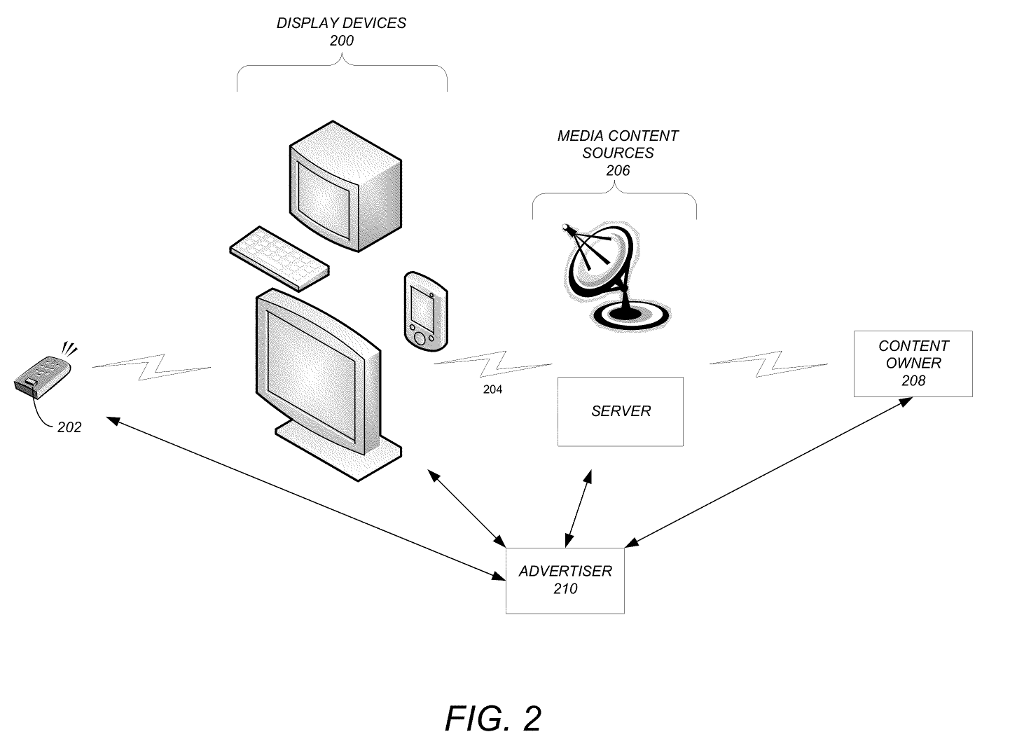

Regardless of the display device utilized, the common component across all such display devices is each display device is configured to display/playback/deliver media content to a user. While embodiments of the invention may be utilized in a variety of contexts and hardware platforms, as described above, exemplary platforms are illustrated in FIGS. 1 and 2.

FIG. 1 is an exemplary hardware and software environment/platform 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may be coupled to, and/or integrated with, other devices, including input/output (I/O) devices such as a keyboard 114, a cursor control device 116 (e.g., a mouse, a pointing device, pen and tablet, touch screen, multi-touch device, etc.) and a printer 128.

In one or more embodiments, computer 102 may be coupled to, or may comprise, a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television 134, television set top box, or other internet enabled device 134 executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108, to provide output and results.

Output/results may be presented on the display 122 or provided to another device (e.g., device 134) for presentation or further processing or action. In one embodiment, the display 122/134 comprises a liquid crystal display (LCD) having a plurality of separately addressable liquid crystals. Alternatively, the display 122/134 may comprise a light emitting diode (LED) display having clusters of red, green and blue diodes driven together to form full-color pixels. Each liquid crystal or pixel of the display 122/134 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118. Although the GUI module 118 is depicted as a separate module, the instructions performing the GUI functions can be resident or distributed in the operating system 108, the computer program 110, or implemented with special purpose memory and processors.

In one or more embodiments, the display 122/134 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs). Alternatively, display 122/134 may consist of a television display device that has a built in tuner/receiver or is connected to a set-top-box configured to receive media content.

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program 110 instructions. In one embodiment, the special purpose processor is an application specific integrated circuit (ASIC).

The computer 102 may also implement a compiler 112 that allows an application or computer program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that were generated using the compiler 112.

The computer 102 also optionally comprises an external communication device such as a modem, satellite link, Ethernet card, or other device for accepting input from, and/or providing output to, other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program 110 instructions which, when accessed, read and executed by the computer 102, cause the computer 102 to perform the steps necessary to implement and/or use the present invention or to load the program of instructions into a memory, thus creating a special purpose data structure causing the computer 102 to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 102.

FIG. 2 illustrates the interaction between different components of a system/platform of embodiments of the invention. As illustrated, display devices 200 are used to display the media content. Such display devices 200 include cellular devices, television monitors, computers, computer monitors, etc.

The display devices 200 receive the media content across network 204 from media content sources 206. Network 204 may consist of a cellular network, satellite network, broadband network, or any type of network capable of transmitting media content. Such media content sources 206 may include broadcasters (e.g., one of the broadcast networks), media content providers (e.g., a cable provider such as Comcast™, satellite provider such as DirecTV™, etc.), computers (e.g., a server or other computer connected to display devices 200 and/or configured to receive content and deliver such content to display devices 200). Further, such computers may be configured to utilize a media player (e.g., Windows™ Media Player™, Quicktime™, etc.) to display media content on a display device 200.

Media content sources 206 may receive such content from content owners 208 (e.g., movie/television studios, private individuals, record companies, etc.).

Advertisements that are displayed in accordance with embodiments of the invention are received from advertiser 210. As used herein, advertisements may be static images (display advertisements) or video advertisements or a combination of both. Advertiser 210 may communicate/transmit advertisements to any of the entities involved (e.g., content owner 208, media content sources 206, and/or display devices 200). As used herein, an advertiser may be an actual advertiser, an advertising network (e.g., Specific Media™), an advertising exchange, an advertising server, or any system or combination of systems that delivers an advertising creative to another system or device. In yet another embodiment, remote control 202 may also have display capabilities, and advertisements may be displayed on remote control 202 as well.

When advertiser 210 communicates with media content sources 206, the advertiser 210 may negotiate with media content sources 206 to determine the cost, length of time, etc. for placement of an advertisement. Thereafter, the advertisement may be inserted by media content sources 206 into the media content. Alternatively, a placeholder may be specified in the media content with the advertisement delivered to display devices 200 for delivery to the user/consumer. Consequently, advertisements may be integrated into the media content or may be delivered separately from such media content. Further, in different embodiments, each component (e.g., the content owner 208, media content sources 206, and/or display devices 200) may have the ability to control the advertisement that is displayed/delivered to a user/consumer.

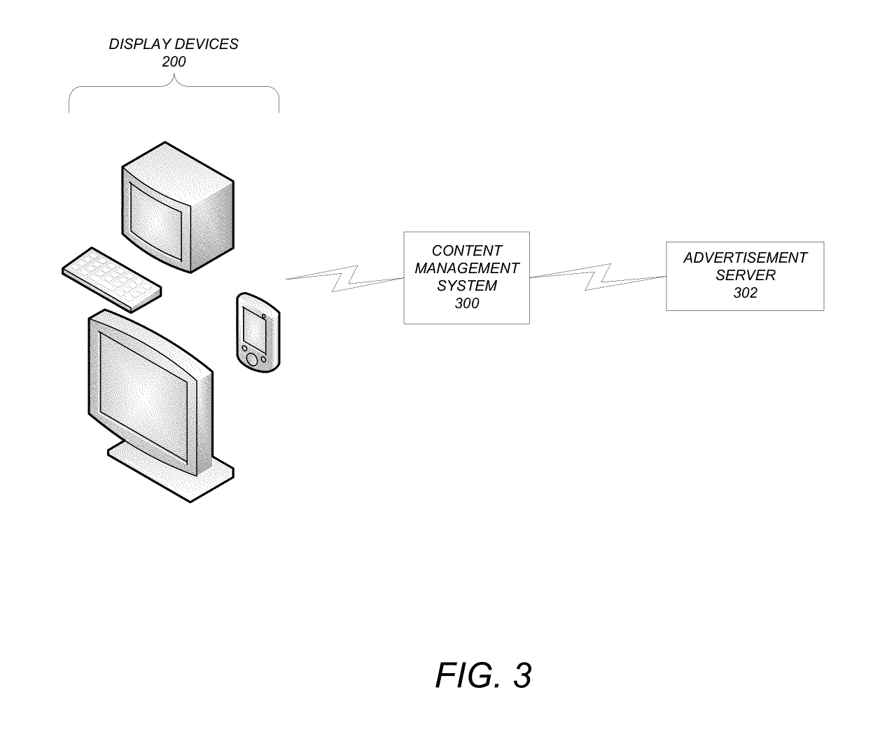

FIG. 3 illustrates a CMS 300 that communicates with an advertisement server 302 to receive an advertisement package for future display on display devices 200 (that are within the control of CMS 300) in accordance with one or more embodiments of the invention. CMS 300 calls the advertisement server 302 in real-time for media content and/or advertisements. Advertisement server 302 packages up digital advertisements for future display schedules. In response to the call by CMS 300, advertisement server 302 transmits a container of digital assets packaged up to show at a later date. In this regard, advertisement server 302 packages up various advertisements that ad server 302 knows will be eligible and within budget constraints and utilizes deferred impression tracking that is posted at a later date to perform any necessary accounting.

Detailed Workflow and Implementation

Terminology

Time Window—An input into the advertisement package request that designates the number of days (or other unit of measurement) in the future that ads will be shown. For example, requesting an ad package with time_window=7 means that the ads will be shown over the next week (i.e., 7 days).

Number of Ads—The number of ads that are being requested by the CMS 300 (i.e., from the ad server 302). As an example, if the CMS 300 specifies a value of 10 for “number_of_ads”, the ad server 302 may deliver back ten (10) distinct ads to show.

Content Management System (CMS) (also referred to as a content management platform)—The offline network that powers content and advertising delivery in a local network. For example, a CMS may include the hard-drive/computer that powers all airplane in-flight media. In one or more embodiments of the invention, the system that delivers the advertisements to offline devices may be separate from the system that requests and receives an advertisement package from an ad server 302. Thus, in such embodiments, the CMS 300 may interact with a secondary/3^{rd} party system that requests/receives the advertisement package and content that is then loaded onto the CMS. In alternative embodiments, the CMS is integrated into/incorporates such functionality. As used herein, embodiments of the invention are intended to include both single systems as well as separate systems that together are referred to as a CSM.

Publisher—The party that manages the offline content management system/platform.

Package—The container of creative assets (number of ads size) delivered as a response from the ad server 302 to an ad scheduler request (e.g., by CMS 300).

Basic Workflow

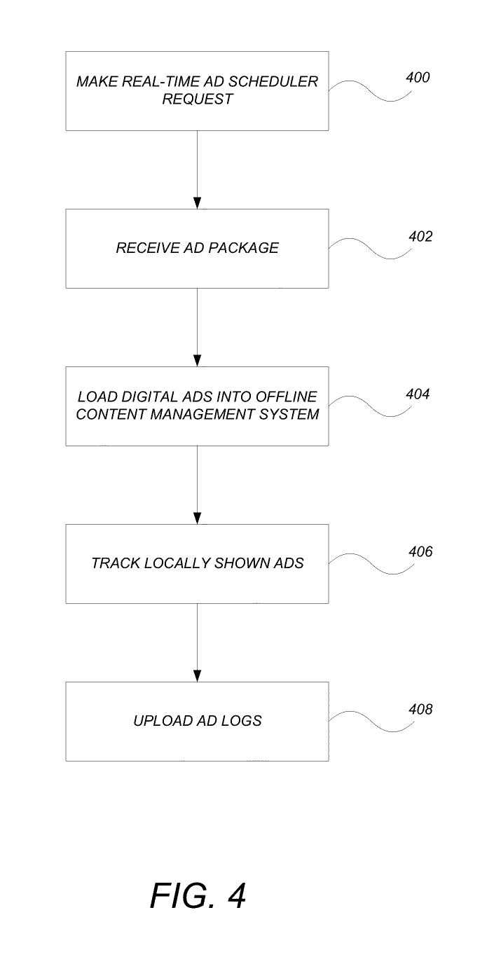

FIG. 4 illustrates the logical flow for utilizing an ad package in accordance with one or more embodiments of the invention.

At step 400, the CMS 300 makes a real-time ad scheduler request to an ad server 302.

At step 402, the CMS 300 receives the advertisement package (e.g., consisting of a container of digital ad assets) from the ad server 302.

At step 404, the CMS 300 loads the digital ads from the (received) package. Such a loading may consist of loading the advertisements onto a hard drive or a location that enables distribution to/within the local network (e.g., on a hard drive of an airplane). In one or more embodiments, an avionics or 3^{rd} party system may load the advertisements onto the CMS 300 or a similar content manage platform.

At step 406, the advertisements that are shown locally (e.g., on devices 200 within the local/offline network) are tracked. The tracking may be performed by the CMS 300 or a party (e.g., the Publisher) responsible for performing such tracking (e.g., a third party application). The tracking may be stored in advertisement logs.

At step 408, the CMS 300 uploads the advertisement logs (and/or the results of the tracking) to the ad server 302 as if the ads were shown in real-time.

Eligibility

The ad server 302 may only consider ads that are eligible within the Time Window that is being requested. For example, if the time_window=14, then the ad server 302 may pick ads that are guaranteed to be eligible in terms for the next two (2) weeks. In another example, the ad server 302 may pick multiple ads that are guaranteed to be eligible for different time periods (e.g., one group of ads eligible a 7-day time window beginning today and another group of ads eligible for a 7-day time window that begins in 7 days). Other eligibility considerations may also be utilized such as budget, campaign flight dates, targeting, etc. In one or more embodiments, user specific targeting may not be considered (meaning ads will be national branding advertisements). Alternatively, embodiments of the invention may perform user/group specific targeting as described in further detail below.

Reporting

The CMS 300 (and/or the publisher) tracks all ads that are shown in real-time on display devices 200. Such tracking may be stored in cache and may occur whenever the CMS 300 is offline (e.g., during flight or when network connectivity is unavailable). Similar to when a user consumes a piece of media on the flight (e.g., a short form show, a movie, etc.), the CMS 300 tracks all advertisement impressions locally. Thereafter, the CMS 300 generates a log file (e.g., a CSV [comma separated values] log) that may be in the same/similar format as a regular impression log file (for systems that have active Internet connections) that is recorded on/provided to ad server 302. All of the publisher logs have the actual impression deliver date on them. Once the CMS 300 is connected to the Internet (e.g., airplane is grounded for refueling), the CMS 300 bulk uploads the logs to the ad server 302. Once uploaded, the ad server 302 will have a matching ad request to ad impression tracking log for all ads that were shown.

Impression Counting

Embodiments of the invention utilize “deferred” impression tracking functionality that enables accurate video advertising reporting among other things. This same functionality can be leveraged to count impressions for ads contained in the ad package/container. As part of an ad scheduler request (e.g., step 400), the ad CMS 300 outputs/transmits one high-level ad scheduler log that contains all of the custom parameters (e.g., the time window), as well as requests for the specified number of ad requests. Alternatively, the ad server 302 may return such a log to the CMS 300 (in response to the ad scheduler request) that the CMS 300 can then use/update with ad impression information.

To ensure that the impression tracking functionality is not subverted or tampered with, the log file may be encrypted using known encryption functionality (e.g., private-key/public-key decryption algorithms) and may be digitally signed for authenticity. Further, confirmation of receipt of the log-file may be returned to the CMS 300. Such a confirmation may also be encrypted and digitally signed. Such a confirmation may also include the information received by ad server 302.

Targeting

User targeting may be unavailable in embodiments of the invention. Alternatively, similar to television advertisers targeting groups of users in a DMA (designated market area) or household, targeting may be performed at a granular level such as an “airline-flight” combination targeting. In this regard, targeting may be based on a combination of the airline (e.g., American Airlines™, Virgin America™, etc.) and the destination/flight (e.g., Las Vegas, Houston, etc.). For example, Virgin America™ flights to Las Vegas may have a certain flyer persona, compared to United™ flights to Houston. As an alternative option, targeting may be based on the destination city. Further, such targeting may be local advertising (e.g., advertising products/services in the destination city). Alternatively, targeting may be based on just the airline (e.g., American Airlines™, Virgin America™, etc.), or just the flight (e.g., destination, origination-destination, etc.). Further, targeting may be based on any type/method of transportation including air, train, boat, space, etc.

Targeting may also utilize information available from the transportation provider (e.g., the airline, cruise ship, etc.). For example, an airline may provide passenger information (such as the name, birthday, gender, etc.) as well as the seat location of such a user (e.g., window, middle, aisle, first class, business class, general class, etc.). In response, a particular ad may be provided to such a user.

In one or more embodiments of the invention, several different advertisement packages may be provided by an ad server 302. Each ad package may have a profile or may be intended for delivery to persons within a particular profile. For example, if the CMS 300 is a cruise ship, one ad package may be intended for children between the ages of 5 and 20, a second ad package for persons aged 21-30, a third ad package for persons aged 31-50, etc. The CMS 300 may then utilize a particular ad package at certain times of day and/or at certain locations on the ship. For example, the ad package for children may be displayed in a “kid's club” or youth area of the ship, the ad package for persons aged 21-30 may be utilized to display ads at bars or the casino, and the ad package for persons over 30 may be utilized on displays at shows, in the eating areas, or during bingo play.

Similarly, different ad packages may be provided and utilized to select ads to be delivered to persons on an airplane based on information known about the user. In addition, a user's profile information may be established in real-time. For example, personal video playback devices may be utilized at every seat on certain airlines. Depending on the media selected/viewed by the user, an advertisement from an advertisement package having a certain profile may be selected/delivered to such a user.

Alternative Embodiments

While embodiments of the invention are directed to networks that do not have an active/continuous Internet connection, alternative embodiments of the invention may be utilized in systems that maintain such an Internet connection. In this regard, rather than delivering advertisements one at a time, advertisement packages containing numerous advertisements may be delivered to an individual user, a server managing a network, etc.

In such an implementation, a CMS 300 may be installed on a user's machine (and/or a server) and is configured to receive the advertisement package and deliver advertisements for display by a user. The CMS 300 may be configured to select particular advertisements to be displayed. Alternatively, advertisements may be pre-selected by an ad server 302 and the CMS 300 delivers the pre-selected advertisements to one or more users.

Such a methodology may be utilized in order to minimize the bandwidth consumed by advertisements (e.g., in a limited bandwidth system). In this regard, an advertisement package may be delivered to the CMS 300 during low bandwidth usage times (e.g., the middle of the night), at designated time intervals, or based on a variety of different factors. Further, by delivery of a group of advertisements in advance, the time taken to deliver such advertisements to a user for display may be reduced rather than requiring a user to receive an advertisement. For example, if a user is watching an Internet video, rather than having to wait for delivery of a commercial at the time the video is requested, the pre-delivered advertisement from an advertisement package may be selected and delivered to the user.

In yet another embodiment of the invention, the CMS 300 may have the option of either delivering an advertisement from an existing/cached advertisement package OR selecting a new advertisement to be retrieved and delivered to the user. For example, if the CMS 300 determines that a user's bandwidth at a particular time is limited, the CMS 300 may select an advertisement from the advertisement package.

However, if during a user's Internet session, the bandwidth improves, a new advertisement may be requested by the CMS 300. Accordingly, real-time decisions regarding advertisements to be delivered to the user may be performed by the CMS 300.

Factors that may influence the advertisement delivered to the user may be based on the profile (and/or parameters) of the advertisement package(s) already received by the CMS 300 versus the profile of the user(s) receiving the advertisement. For example, if the profile of an advertisement package is for males aged 21-30, but the user's profile indicates a female and/or male over aged 40, a new advertisement package and/or new advertisement may be requested by the CMS 300. Thus, the CMS 300 may be utilized to request and deliver advertisements on an advertisement-by-advertisement basis and/or on an advertisement package basis.

An advertisement package may also be delivered on a per-session basis to provide a variety of advertisements for a single/group of advertisers, as described in patent application Ser. No. 14/061,398, cross referenced above and incorporated by reference herein.

In addition to the above, the type of file that is provided/delivered to a user may vary depending on various factors. For example, some screens may only support MPEG (motion pictures expert group) for video. In an advertisement package request, a CMS 300 may have the ability to request five (5) different 300×250 advertisements and ten (10) different video advertisements in MPEG1 and five (5) different advertisements in MPEG2 for example. Such a request would support the ability to deliver advertisements to devices having varying display capabilities. For example, a first class passenger may have a nicer screen than a coach passenger. Accordingly, the first class passenger may be delivered an advertisement in a different format (i.e., that is formatted for display on a nicer screen) than that of the coach passenger. Further, the first class passenger may receive an advertisement that targets a different class of consumers than that of the coach passenger.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for displaying advertisements, comprising:
(a) issuing a request for advertisements to an advertisement server;
(b) receiving, from the advertisement server, an advertisement package comprised of a set of advertisements;
(c) loading the set of advertisements from the advertisement package;
(d) delivering one or more of the advertisements in the set of advertisements for display by one or more display devices;
(e) tracking, in a log, the one or more advertisements that are displayed by the one or more display devices; and
(f) uploading the log to the advertisement server.

2. The method of claim 1, wherein:
the request includes a time window that designates a number of days in the future that the advertisements in the advertisement package will be shown; and
the package only includes advertisements that are guaranteed to be eligible in term for the time window.

3. The method of claim 1, wherein:
the package only includes advertisements that are eligible based on a defined budget.

4. The method of claim 1, wherein:
the request specifies a number of advertisements that are being requested.

5. The method of claim 1, wherein:
the request is issued by a content management system that powers content and advertisement delivery in a local network.

6. The method of claim 5, wherein:
the content management system is located on an airplane; and
the local network provides for display devices located at passenger seat locations.

7. The method of claim 1, wherein:
the issuing, requesting, and uploading are performed when an Internet connection is available; and
the delivering and tracking are performed when the Internet connection is not constantly available.

8. A content management system (CMS) for displaying advertisements, comprising:
(a) a computer having a memory;
(b) an application executing on the computer, wherein the application is configured to:
(1) issue a request for advertisements to an advertisement server;
(2) receive, from the advertisement server, an advertisement package comprised of a set of advertisements;
(3) load the set of advertisements from the advertisement package;
(4) deliver one or more of the advertisements in the set of advertisements for display by one or more display devices;
(5) track, in a log, the one or more advertisements that are displayed by the one or more display devices; and
(6) upload the log to the advertisement server.

9. The CMS of claim 8, wherein:
the request includes a time window that designates a number of days in the future that the advertisements in the advertisement package will be shown; and
the package only includes advertisements that are guaranteed to be eligible in term for the time window.

10. The CMS of claim 8, wherein:
the package only includes advertisements that are eligible based on a defined budget.

11. The CMS of claim 8, wherein:
the request specifies a number of advertisements that are being requested.

12. The CMS of claim 8, wherein:
the application is further configured to power content and advertisement delivery in a local network.

13. The CMS of claim 12, wherein:
the CMS is located on an airplane; and
the local network provides for display devices located at passenger seat locations.

14. The CMS of claim 8, wherein:
application is configured to perform the issue, request, and upload steps when an Internet connection is available; and
the application is configured to perform the deliver and track steps when the Internet connection is not constantly available.

15. A non-transient computer readable storage medium encoded with computer program instructions which when accessed by a computer cause the computer to load the program instructions to a memory therein creating a special purpose data structure causing the computer to operate as a specially programmed computer, executing a method of displaying advertisements, comprising:
(a) issuing, in the specially programmed computer, a request for advertisements to an advertisement server;
(b) receiving, in the specially programmed computer, from the advertisement server, an advertisement package comprised of a set of advertisements;
(c) loading, in the specially programmed computer, the set of advertisements from the advertisement package;
(d) delivering, via the specially programmed computer, one or more of the advertisements in the set of advertisements for display by one or more display devices;
(e) tracking, in the specially programmed computer, in a log, the one or more advertisements that are displayed by the one or more display devices; and
(f) uploading the log, from the specially programmed computer to the advertisement server.

16. The non-transient computer readable storage medium of claim 15, wherein:
the request includes a time window that designates a number of days in the future that the advertisements in the advertisement package will be shown; and
the package only includes advertisements that are guaranteed to be eligible in term for the time window.

17. The non-transient computer readable storage medium of claim 15, wherein:
the package only includes advertisements that are eligible based on a defined budget.

18. The non-transient computer readable storage medium of claim 15, wherein:
the request specifies a number of advertisements that are being requested.

19. The non-transient computer readable storage medium of claim 15, wherein:
the request is issued by a content management system that powers content and advertisement delivery in a local network.

20. The non-transient computer readable storage medium of claim 19, wherein:
the content management system is located on an airplane; and
the local network provides for display devices located at passenger seat locations.

21. The non-transient computer readable storage medium of claim 15, wherein:
the issuing, requesting, and uploading are performed when an Internet connection is available; and
the delivering and tracking are performed when the Internet connection is not constantly available.
